(19) United States
(12) Patent Application Publication
(10) Pub. No.: US 2008/0136744 A1
(43) Pub. Date: Jun. 12, 2008

(54) Plasma Display Device and Power Supply Module

(76) Inventors: Shigetoshi Tomio, Yokohama (JP); Ken Kumakura, Yokohama (JP); Masashi Yamazaki, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/847,620

(22) Filed: Aug. 30, 2007

(30) Foreign Application Priority Data
Dec. 12, 2006 (JP) 2006-335024

(51) Int. Cl. G09G 3/28; G09G 3/10

(52) U.S. Cl. 345/60; 315/169.4; 345/211; 346/67

(57) ABSTRACT

A plasma display device includes a PDP module having a plasma display panel (PDP), a drive circuit applying positive and negative sustain pulses having the same absolute value to the PDP, and a voltage detection circuit detecting voltage from the power supply module, and a power supply module having voltage output terminals connected to voltage input terminals of the PDP module through connection means, generating a positive voltage required to produce positive sustain pulses and a negative voltage required to produce negative sustain pulses from an AC supply voltage, both pulses being supplied to the PDP module, outputting both voltages from the voltage output terminals, and performing a feedback control for the output voltage based on a detection result from the voltage detection circuit, thereby effectively generating the positive and negative voltages required to produce the positive and negative sustain pulses without complex circuit configuration.

### CROSS-REFERENCE TO RELATED APPLICATIONS

This application is based upon and claims the benefit of priority from the prior Japanese Patent Application No. 2006-335024, filed on Dec. 12, 2006, the entire contents of which are incorporated herein by reference.

### BACKGROUND OF THE INVENTION

1. Field of the Invention

The present invention relates to a plasma display device in which positive and negative sustain pulses are applied to a plasma display panel to sustain discharge, and a power supply module used therein.

2. Description of the Related Art

As flat-panel display devices, plasma display devices with plasma display panels (PDPs) have been made commercially practical, which are designed to cause pixels on a screen to emit light based on display data. The plasma display device displays images by: selecting a capacitive load, which is display means, by addressing it according to display data; and applying a sustain pulse to electrodes of the capacitive load to sustain discharge between the electrodes of the selected capacitive load and therefore to generate light emission.

Proposed plasma display devices include the one in which, by applying a positive sustain pulse to one electrode of a capacitive load while applying a negative sustain pulse to the other electrode of the capacitive load, sustain discharge between the electrodes of the selected capacitive load is performed due to a potential difference of the sustain pulses which are different in polarity from each other (see, e.g., International Publication No. WO 2004/32108).

FIG. 7 illustrates problems that the present invention solves. FIG. 7 shows an example of the plasma display device in which positive and negative sustain pulses are applied to sustain discharge. The plasma display device comprises a plasma display panel module (PDP module) 71 and a power supply module 79, both of which are connected through connection means such as a connector and cable.

The PDP module 71 includes a plasma display panel (PDP) 72, an X sustain circuit 73, a Y sustain circuit 74, an address drive circuit 75 and a control circuit (logic circuit) 76.

The X sustain circuit 73 and Y sustain circuit 74 apply positive sustain pulses of a voltage (+Vs) and negative sustain pulses of a voltage (−Vs) to a plurality of X electrodes (sustain electrodes) and a plurality of Y electrodes (scan electrodes) formed in the PDP 72. In order to select pixels to be displayed, the Y sustain circuit 74 applies scan pulses to the Y electrodes in a line sequential manner, and the address drive circuit 75 applies address pulses to address electrodes according to display data. The control circuit 76 generates control signals based on the input display data, clock signal, horizontal synchronization signal, vertical synchronization signal and so on to control the X sustain circuit 73, Y sustain circuit 74, and address drive circuit 75 with the generated control signals.

The power supply module 79 generates DC supply voltages (+Vs), Va and Vcc from an AC supply voltage and supplies the DC supply voltages to the PDP module 71. The voltage (+Vs) is used to generate the sustain pulses, the voltage Va is used to generate the address pulses, and the voltage Vcc is used to operate the logic circuit and so on in the PDP module 71.

FIG. 7 illustrates a circuit configuration relating to only the generation of the voltage (+Vs) in the power supply module 79. The power supply module 79 comprises an input rectifier circuit 81, a transformer 82, a diode circuit 83, a voltage detector 84, a capacitance (electrolytic capacitor) C72, a power control circuit (control IC) 85, a discharge circuit 86 and a transistor Q71 functioning as a switching element.

The input rectifier circuit 81, which is connected to an AC power supply 80, rectifies AC supply voltage from the AC power supply 80. The transformer 82 has a primary winding whose one end is connected to the input rectifier circuit 81 and whose other end is connected to the input rectifier circuit 81 via the transistor Q71. The power control circuit 85 performs an ON/OFF control on the transistor Q71 to control supply and suspension of electric currents for the primary winding of the transformer 82, and thereby generating alternating-current voltage in a secondary winding. The alternating-current voltage generated in the secondary winding of the transformer 82 is rectified in the diode circuit 83 comprised of diodes D71 and D72 connected in parallel, and smoothed in the electrolytic capacitor C72 to generate a voltage (+Vs) that is then output from an output terminal.

The voltage detector 84 detects the output voltage and supplies the detection result to the power control circuit 85. The power control circuit 85 controls the ON/OFF duty ratio of the transistor Q71 in response to the detection result from the voltage detector 84 so that the output voltage reaches the voltage (+Vs). For example, the power control circuit 85 controls the transistor Q71 to stay in the ON state longer when the output voltage is lower than the voltage (+Vs), while controlling the transistor Q71 to stay in the OFF state longer when the output voltage is higher than the voltage (+Vs). The discharge circuit 86 is used to short-circuit the output terminal of the voltage (+Vs) to ground in order to release charges.

The voltage (+Vs), which is to be supplied from the power supply module 79 to the PDP module 71, is input to the X sustain circuit 73 and supplied to an internal circuit of the X sustain circuit 73, a DC/DC converter 78 and the Y sustain circuit 74 via a voltage/current detector 77 for detecting voltage/current. The DC/DC converter 78 generates voltage (−Vs) by inverting the input voltage (+Vs) through a charge pump method and supplies the voltage (−Vs) to the internal circuit in the X sustain circuit 73 and the Y sustain circuit 74.

The voltage Va, which is to be supplied from the power supply module 79 to the PDP module 71, is supplied to the address drive circuit 75 via the X sustain circuit 73. The voltage Vcc, which is to be supplied from the power supply module 79 to the PDP module 71, is supplied to the control circuit (logic circuit) 76 and X sustain circuit 73 as well as the Y sustain circuit 74 and address drive circuit 75 via the X sustain circuit 73.

As described above, the negative voltage (−Vs), which is required to generate the negative sustain pulses, is generated in the X sustain circuit 73 in the PDP module 71 from the voltage (+Vs) supplied from the power supply module 79. Such generation of the negative voltage (−Vs) by the DC/DC converter 78 in the X sustain circuit 73 causes poor conversion efficiency due to the voltage inversion of the input voltage (+Vs) through the charge pump method and a cost increase due to a large number of components required in a circuit for generating the voltage (−Vs)

### SUMMARY OF THE INVENTION

The present invention has an object to effectively generate a positive voltage and negative voltage required to produce positive and negative sustain pulses to be applied to the plasma display panel without complex circuit configuration.

The plasma display device of the present invention comprises a plasma display panel module and a power supply module. The plasma display panel module includes: a plasma display panel with a plurality of electrodes formed therein; a drive circuit applying positive and negative sustain pulses, both having the same absolute voltage value, to the electrodes of the plasma display panel; and a first voltage detection circuit detecting voltages supplied from the power supply module. The power supply module includes voltage output terminals connected to voltage input terminals, to which voltages are input, of the plasma display panel module through connection means. The power supply module generates, from an AC supply voltage, a positive voltage required to produce the positive sustain pulses and a negative voltage required to produce the negative sustain pulses, both having the same absolute voltage value and being supplied to the plasma display panel module, and outputs the positive and negative voltages from the voltage output terminals. The power supply module uses a detection result supplied from the first voltage detection circuit to perform a feedback control for the output voltage.

A power supply module of the present invention includes voltage output terminals electrically connected to voltage input terminals of a plasma display panel module through connection means, generates, from an AC supply voltage, DC supply voltages to be supplied to the plasma display panel module and outputs the DC supply voltages from the voltage output terminals. The power supply module generates and outputs a positive voltage required to produce positive sustain pulses and a negative voltage required to produce negative sustain pulses, both having the same absolute voltage value and being applied to the electrodes of the plasma display panel in the plasma display panel module and performs a feedback control for the output voltage based on a detection result supplied from an external first voltage detection circuit.

### BRIEF DESCRIPTION OF THE DRAWINGS

FIG. 1 illustrates a configuration example of a plasma display device according to an embodiment of the present invention;

FIG. 2 illustrates an example of driving waveforms of the plasma display device shown in FIG. 1;

FIG. 3 illustrates a configuration example of a power supply module in the embodiment;

FIGS. 4A and 4B illustrate configuration examples of a sustain circuit in the embodiment;

FIGS. 5A and 5B illustrate other configuration examples of the sustain circuit in the embodiment;

FIGS. 6A and 6B illustrate other configuration examples of the power supply module to perform feedback control of the output voltage; and

FIG. 7 illustrates an example of plasma display devices in which positive and negative sustain pulses are applied to sustain discharge.

### DETAILED DESCRIPTION OF THE PREFERRED EMBODIMENTS

With reference to the drawings, an embodiment of the present invention will be described below.

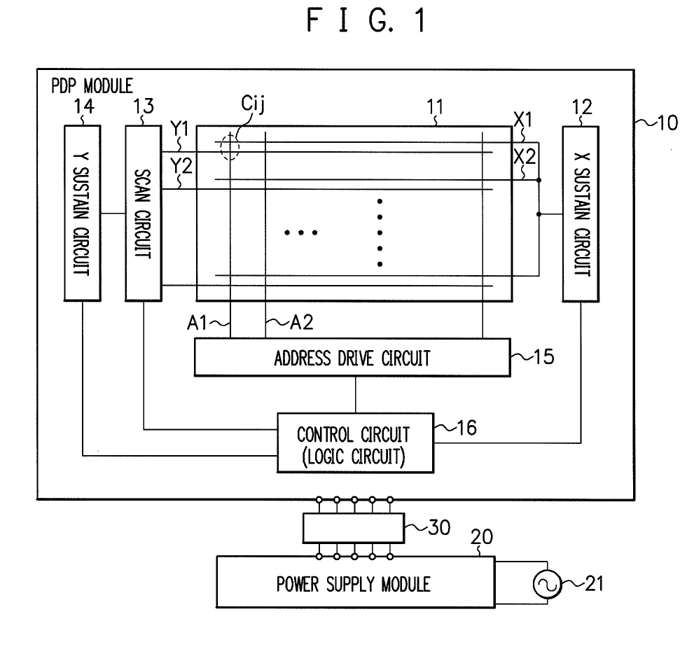

FIG. 1 is a block diagram showing a configuration example of a plasma display device according to the embodiment of the present invention. The plasma display device of the embodiment comprises a plasma display panel (PDP) module 10 and a power supply (PSU) module 20. The PDP module 10 is electrically connected to the power supply module 20 through connection means 30 such as a connector and cable.

The PDP module 10 includes a plasma display panel 11, an X sustain circuit 12, a scan circuit (scan driver) 13, a Y sustain circuit 14, an address drive circuit 15 and a control circuit (logic circuit) 16.

The X sustain circuit 12 is a circuit for repeatedly sustain discharge and supplies a predetermined voltage to X electrodes (sustain electrodes) X1, X2, . . . Hereinafter, the X electrodes X1, X2, . . . are individually or collectively referred to as an X electrode Xi, and i represents a numerical subscript. The X electrode Xi has an end commonly connected to the X sustain circuit 12.

The scan circuit 13 is a circuit for scanning rows in a line sequential manner to select the rows to be displayed, while the Y sustain circuit 14 is a circuit for repeatedly sustain discharge. The scan circuit 13 and Y sustain circuit 14 supply a predetermined voltage to a plurality of Y electrodes (scan electrodes) Y1, Y2, . . . Specifically, the scan circuit 13 is provided with a plurality of switches each corresponding to the Y electrodes Y1, Y2, . . . , and operates the switches so as to sequentially apply scan pulses to the Y electrodes Y1, Y2, . . . during an address period and simultaneously apply sustain pulses from the Y sustain circuit 14 to all of the Y electrodes Y1, Y2, . . . during a sustain period. Hereinafter, the Y electrodes Y1, Y2, . . . are individually or collectively referred to as a Y electrode Yi, and i represents a numerical subscript.

The address drive circuit 15 is a circuit for selecting columns to be displayed and supplies a predetermined voltage to a plurality of address electrodes A1, A2, . . . Hereinafter, the address electrodes A1, A2, . . . are individually or collectively referred to as an address electrode Aj, and j represents a numerical subscript.

The control circuit 16 generates control signals based on externally input display data, clock signal, horizontal synchronization signal and vertical synchronization signal. The control circuit 16 supplies the generated control signals to the X sustain circuit 12, scan circuit 13, Y sustain circuit 14 and address drive circuit 15 to control these circuits 12 to 15.

In the plasma display panel 11, the Y electrodes Yi and X electrodes Xi are rows extending in the horizontal direction in parallel, while the address electrodes Aj are columns extending in the vertical direction. The Y electrodes Yi and X electrodes Xi are alternately placed in the vertical direction. In other words, the Y electrodes Yi and X electrodes Xi are placed in parallel with each other, while the address electrodes Aj are placed in a direction approximately perpendicular to the Y electrodes Yi and X electrodes Xi. The Y electrodes Yi and address electrodes Aj form a two-dimensional matrix with i rows and j columns.

A cell Cij is formed at an intersection of the Y electrode Yi and address electrode Aj and on a corresponding X electrode Xi adjacent thereto. In addition to the cell formed at the intersection of a Y electrode Yi and address electrode Aj and on a corresponding X electrode Xi adjacent thereto, the cell may be formed at an intersection of a Y electrode Yi and address electrode Aj and on a corresponding X electrode X(i+1) adjacent thereto.

This cell Cij corresponds to a subpixel, for example a red subpixel, green subpixel or blue subpixel, and these three color subpixels form one pixel. The panel 11 displays images by lighting up a plurality of two-dimensionally arrayed pixels. The display operation is done by causing the scan circuit 13 and address drive circuit 15 to determine cells to be lit up and the X sustain circuit 12 and Y sustain circuit 14 to repeatedly discharge.

The power supply module 20 generates DC supply voltage from AC supply voltage supplied from the AC power supply 21 and supplies the generated DC supply voltage to the PDP module 10 through the connection means 30. In the embodiment, the power supply module 20 generates, from AC supply voltage, at least a positive voltage (+Vs) required to produce positive sustain pulses, a negative voltage (−Vs) required to produce negative sustain pulses, a voltage Va required to produce address pulses and a voltage Vcc required to operate the logic circuit and so on in the PDP module 10, and outputs the voltages, of which detailed description will be given later.

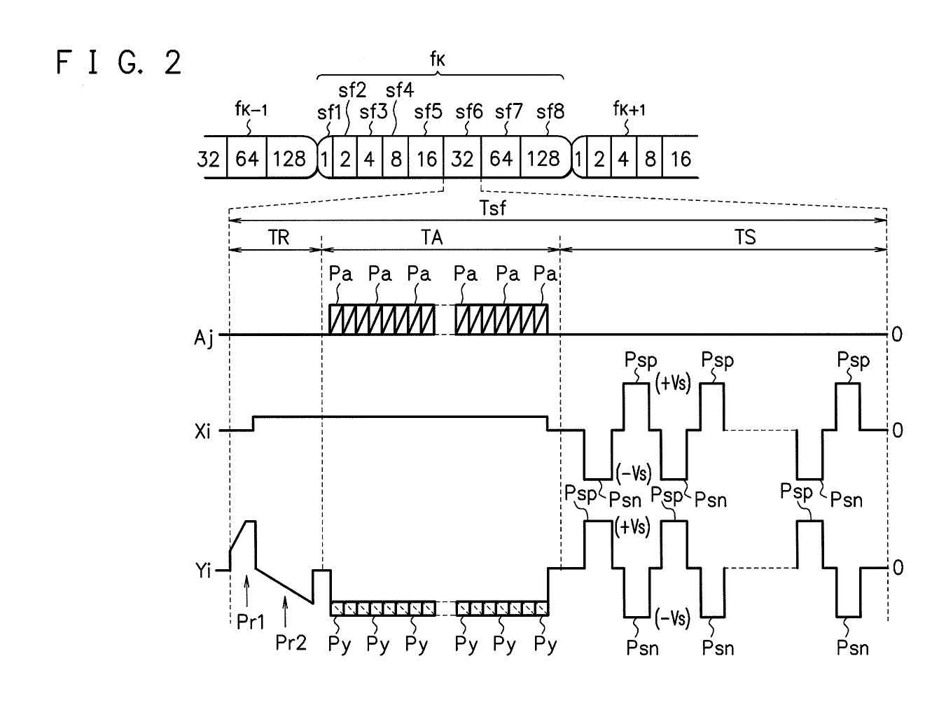

FIG. 2 illustrates an example of driving waveforms of the plasma display device shown in FIG. 1. An image is composed of a plurality of time-series frames f (numerical subscript indicates a display order), such as frames fk−1, fk, fk+1 shown in FIG. 2.

In order to display images, since gradation is reproduced by controlling each pixel unit through a binary lighting control, each frame f is divided into, for example, eight subframes sf1, sf2, sf3, sf4, sf5, sf6, sf7 and sf8. The subframes sf1 to sf8 are modified by weights so as to make their relative intensity ratio approximately 1:2:4:8:16:32:64:128, for example, and the number of discharge to sustain lighting for each of subframes sf1 to sf8 is set.

Each of the subframes sf1 to sf8 is assigned with a subframe period Tsf including a reset period TR, an address period TA and a sustain period TS. In the reset period TR, the cells Cij are initialized. In the reset period TR, a positive ramp wave (a waveform having a positive gradient) Pr1 is applied to the Y electrodes Yi in unison to form a wall charge and then a negative ramp wave (a waveform having a negative gradient) Pr2 is applied in unison to adjust the amount of the wall charge in the cells Cij.

In the address period TA, emission or non-emission of each cell Cij can be selected by means of discharge between the address electrode Aj and the Y electrode Yi, and accompanying discharge between the X electrode Xi and the Y electrode Yi. Specifically, scan pulses Py are successively applied to the Y electrodes Y1, Y2, Y3, . . . and so on. By applying an address pulse Pa to the address electrode Aj corresponding to each of the above scan pulses Py, discharge occurs between the address electrode Aj and the Y electrode Yi. With this discharge, wall charges are produced on the X electrode Xi and the Y electrode Yi, and thus, emission or non-emission of a desired cell Cij can be selected.

In the sustain period TS, the sustain discharge is performed between the X electrode Xi and Y electrode Yi of the selected cell Cij, thereby allowing the cell Cij to emit light. In the sustain period TS, sustain pulses Psp and Psn, which are different in polarity, are applied to the X electrode Xi and Y electrode Yi at the same time. Specifically, when the sustain pulses Psp of the positive voltage (+Vs) are applied to the X electrode Xi, the sustain pulses Psn of the negative voltage (−Vs), which has the opposite polarity to the sustain pulses Psp, are applied to the Y electrodes Yi. Similarly, when the sustain pulses Psp of the positive voltage (+Vs) are applied to the Y electrode Yi, the sustain pulses Psn of the negative voltage (−Vs), which has the opposite polarity to the sustain pulses Psp, are applied to the X electrodes Xi. Accordingly, by using the potential difference between the sustain pulses Psp (Psn) applied to the X electrode Xi and the sustain pulses Psn (Psp) applied to the Y electrode Yi, a discharge occurs in the cells with the wall charge formed in the address period TA, thereby allowing the cells to emit light.

Note that the driving waveform shown in FIG. 2 is an example, and the waveform is not limited to this and could be changed in various ways.

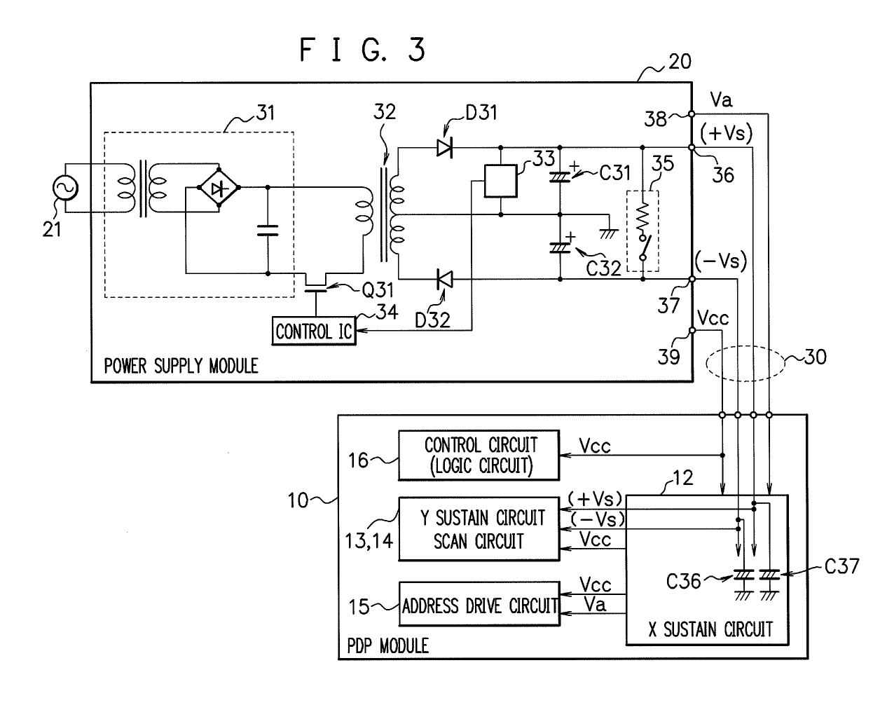

FIG. 3 illustrates a configuration example of the power supply module 20 of the embodiment to describe how to supply the generated voltage. Although FIG. 3 shows only circuit components for generating a positive voltage (+Vs) and negative voltage (−Vs) as components of the power supply module 20, the power supply module 20 also can generate a voltage Va and voltage Vcc. Blocks and other components in FIG. 3 that have the same function of the blocks and other components shown in FIG. 1 are denoted with the same reference numerals.

The power supply module 20 includes an input rectifier circuit 31, a transformer 32, a voltage detector 33, a power control circuit (control IC) 34, a discharge circuit 35, diodes D31, D32, capacitances (electrolytic capacitors) C31, C32 and a transistor Q31 functioning as a switching element.

The input rectifier circuit 31 is connected to the AC power supply 21, which supplies AC supply voltage, rectifies the AC supply voltage and outputs it. The primary winding of the transformer 32 has one end connected to the input rectifier circuit 31 and the other end connected to the input rectifier circuit 31 via the transistor Q31. The transistor Q31 has a gate connected to the power control circuit 34 that performs an ON/OFF control on the transistor Q31.

The secondary winding of the transformer 32 is center-tapped to ground (GND) to have a ground potential. Specifically, regarding the secondary winding of the transformer 32, the number of wire turns from one end of the secondary winding to a position defined as the ground potential is the same as that from the other end of the secondary winding to the position defined as the ground potential.

The secondary winding of the transformer 32 has one end connected to an anode of the diode D31 whose cathode is connected to an output terminal 36 for outputting a positive voltage (+Vs). The electrolytic capacitor C31 is connected between an interconnection point of a cathode of the diode D31 and the output terminal 36 and the ground.

On the other hand, the secondary winding of the transformer 32 has the other end connected to a cathode of the diode D32 whose anode is connected to an output terminal 37 for outputting a negative voltage (−Vs). The electrolytic capacitor C32 is connected between an interconnection point of an anode of the diode D32 and the output terminal 37 and the ground.

The diode D31 and electrolytic capacitor C31 form an output rectifier circuit for a positive voltage (+Vs), while the diode D32 and electrolytic capacitor C32 form an output rectifier circuit for a negative voltage (−Vs). The configuration of the output rectifier circuits including the diodes and capacitors as shown in FIG. 3 is merely an example and is not intended to limit the present invention.

The voltage detector 33 is connected between an interconnection point of the cathode of the diode D31 and the output terminal 36 and the ground, and detects potential at the interconnection point with respect to the ground potential, that is, an output voltage from the output rectifier circuit for the positive voltage (+Vs). In addition, the voltage detector 33 supplies the detection result to the power control circuit 34.

The power control circuit 34 performs an ON/OFF control on the transistor Q31 based on the detection result from the voltage detector 33 so that the output voltage from the output rectifier circuit reaches a desired output voltage. The discharge circuit 35 for discharging accumulated charges is connected between the output terminal 36 and output terminal 37. The discharge circuit 35 is comprised of, for example, a resistor and a switch, both connected between the output terminal 36 and output terminal 37 in series.

AC supply voltage supplied from the AC power supply 21 is rectified in the input rectifier circuit 31 and output therefrom. With the transistor Q31 under the ON/OFF control by the power control circuit 34, the supply and suspension of electric currents to the primary winding of the transformer 32 is regulated, thereby generating an alternating-current voltage in the secondary winding. The generated alternating-current voltage in the secondary winding is rectified in the diode D31 included in the output rectifier circuit, smoothed in the electrolytic capacitor C31 and output from the output terminal 36, while being rectified in the diode D32 included in another output rectifier circuit, smoothed in the electrolytic capacitor C32 and output from the output terminal 37.

Because the secondary winding of the transformer 32 has a center tap having a ground potential as described above, when the output voltage of the output rectifier circuit comprised of the diode D31 connected to one end of the secondary winding and the electrolytic capacitor C31 is (+Vs), the output voltage of the output rectifier circuit comprised of the diode D32 connected to the other end of the secondary winding and the electrolytic capacitor C32 is (−Vs). Therefore, according to the circuit shown in FIG. 3, the output terminals 36 and 37 output voltages having the same absolute value but different polarities.

The output voltage from the output rectifier circuit comprised of the diode D31 and electrolytic capacitor C31 is detected by the voltage detector 33 which then supplies the detection result to the power control circuit 34. The detection result to be supplied from the voltage detector 33 to the power control circuit 34 may be just a value of the output voltage or a difference value between the output voltage and a desired voltage (+Vs).

Based on the detection result supplied from the voltage detector 33, the power control circuit 34 performs a feedback control for the output voltage from the output rectifier circuit comprised of the diode D31 and electrolytic capacitor C31 to control the ON-OFF duty ratio of the transistor Q31 so that the output voltage reaches a desired voltage (+Vs). For example, when the output voltage is lower than the voltage (+Vs), the power control circuit 34 controls the transistor Q31 to stay in the ON state longer, in other words, increases the ON-duty ratio. When the output voltage is higher than the voltage (+Vs), the power control circuit 34 controls the transistor Q31 to stay in the OFF state longer, in other words, decreases the ON-duty ratio.

In the embodiment, as shown in FIG. 3, the output voltage from the output rectifier circuit for a positive voltage (+Vs) is detected by the voltage detector 33, and then the power control circuit 34 controls the transistor Q31 to turn ON/OFF based on the detection result so that the output voltage reaches the desired voltage (+Vs). In other words, in the example shown in FIG. 3, the output-voltage feedback control is performed only on the generated positive voltage (+Vs).

Since a load requiring the positive voltage (+Vs) and a load requiring the negative voltage (−Vs) are approximately equal, even the output-voltage feedback control performed only on the positive voltage (+Vs) makes it possible to generate the negative voltage (−Vs) with high accuracy. It is also possible to obtain the same effect by providing a voltage detector to detect output voltage from the output rectifier circuit for the negative voltage (−Vs) and performing the output-voltage feedback control only on the generated negative voltage (−Vs). In short, the output-voltage feedback control performed only on either one of the generated positive voltage (+Vs) or negative voltage (−Vs) can realize the generation of the other one of the positive voltage (+Vs) or negative voltage (−Vs) with high accuracy, thereby achieving cost reduction. Of course, the output-voltage feedback control can be performed on both generated positive voltage (+Vs) and negative voltage (−Vs).

The voltages (+Vs), (−Vs), Va, Vcc, which were generated in the power supply module 20, are output from the output terminals 36, 37, 38 and 39, respectively. The output terminals 36 to 39 of the power supply module 20 are connected to the voltage input terminals of the PDP module 10 through connection means 30 such as a connector and cable. The voltages (+Vs), (−Vs), Va, Vcc output from the power supply module 20 are supplied to the PDP module 10 through connection means 30.

The positive voltage (+Vs) and negative voltage (−Vs), which are to be supplied from the power supply module 20 to the PDP module 10, are input to an X sustain circuit 12 and then input to a Y sustain circuit 14/scan circuit 13 through the X sustain circuit 12. The positive voltage (+Vs) and negative voltage (−Vs), which are to be supplied to the PDP module 10, can be input to the Y sustain circuit 14/scan circuit 13 without passing through the X sustain circuit 12.

In order to supply charges required for the sustain pulses to discharge gas in PDP, the PDP module 10 includes electrolytic capacitors C36 and C37 on supply lines of the positive voltage (+Vs) and negative voltage (−Vs), respectively. Making the capacitance of the electrolytic capacitors C36 and C37 of the PDP module 10 larger than the capacitance of the corresponding electrolytic capacitors in the power supply module 20 prevents the variations in output voltage of the power supply module 20, thereby suppressing noise generated by the transformer 32 and other components due to sudden changes in the output voltage.

The voltage Va, which is to be supplied from the power supply module 20 to the PDP module 10, is input to the address drive circuit 15 via the X sustain circuit 12. The voltage Vcc, which is to be supplied from the power supply module 20 to the PDP module 10, is input to the X sustain circuit 12 and control circuit (logic circuit) 16, and the voltage Vcc having entered the X sustain circuit 12 is input to the Y sustain circuit 14/scan circuit 13 and the address drive circuit 15.

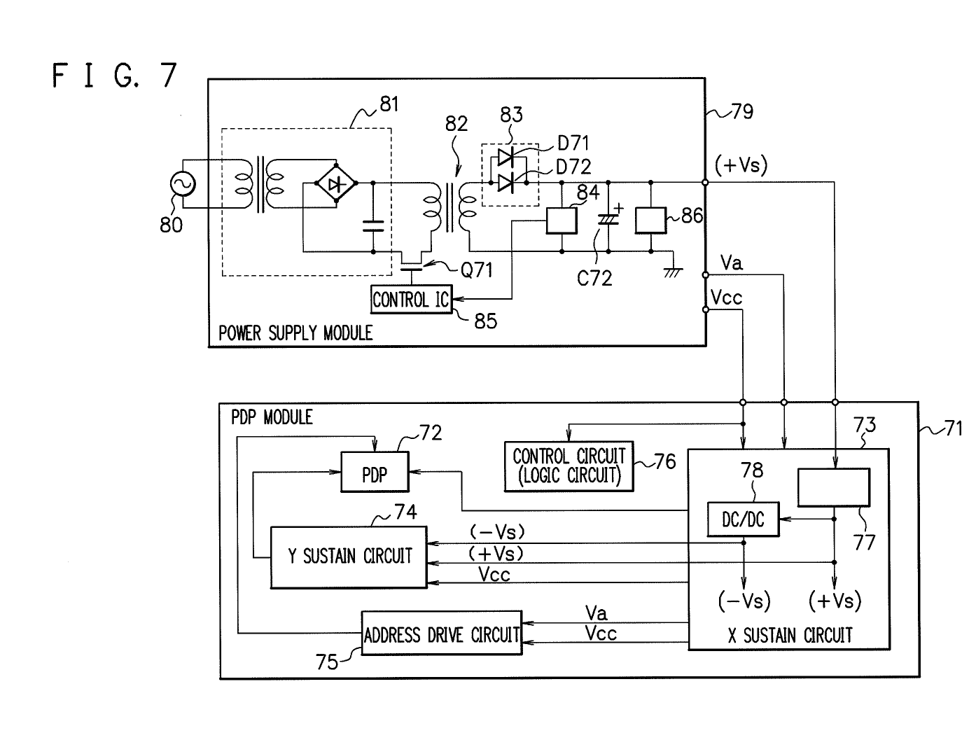

According to the embodiment in which a circuit for generating the positive voltage (+Vs) and a circuit for generating the negative voltage (−Vs) are formed with a ground potential taken from a center tap of the secondary winding of the transformer 32, it is possible to generate and output the voltages that have the same absolute value but different polarities. Since the power supply module is originally comprised of, in addition to a transformer, diodes and electrolytic capacitors, a voltage (+Vs) converter for generating a positive voltage (+Vs) from an AC supply voltage as shown in FIG. 7, the generation of the positive voltage (+Vs) and negative voltage (−Vs) can be achieved with a slight cost increase for modifying the configuration of the transformer. There is also no need to perform voltage conversion and so on in the PDP module 10 (e.g. in the X sustain circuit 12), thereby removing losses in the PDP module 10 and generating the positive voltage (+Vs) and negative voltage (−Vs) more effectively than usual.

Since the voltage (+Vs) generated in the power supply module is also used to produce the voltage (−Vs) that drives the circuits and so on in the PDP module according to the configuration shown in FIG. 7, the output rectifier circuit includes a diode circuit having diodes connected in parallel. However, the parallel-connected diodes can be separately placed in each output rectifier circuit because driving with the voltage (+Vs) and driving with the voltage (−Vs) are clearly distinguished from each other in this embodiment, and therefore there is no need to increase the number of diodes.

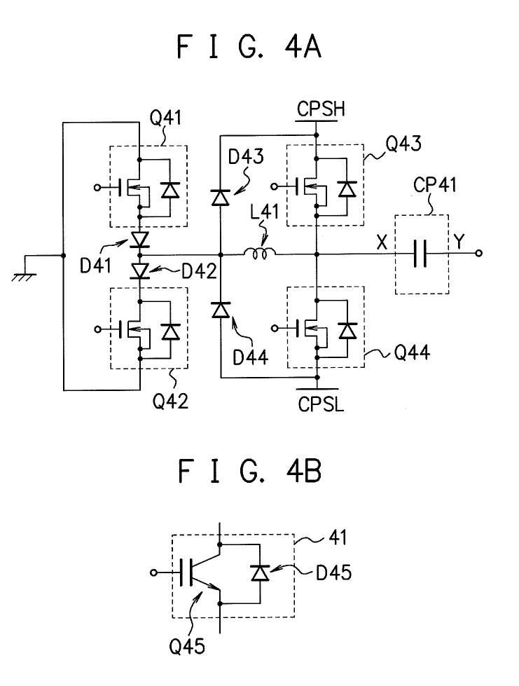

FIGS. 4A and 4B are circuit diagrams showing configuration examples of the sustain circuits 12 and 14 in the present embodiment. Although the configuration example illustrated in FIG. 4A is the X sustain circuit 12, the Y sustain circuit 14 has also the same configuration. The sustain circuit is a circuit to apply sustain pulses Psp and Psn to X electrodes Xi and Y electrodes Yi.

In FIG. 4A, panel capacitance CP41 is a capacitance between the X electrode Xi and Y electrode Yi and corresponds to a capacitive load which is display means. Transistors Q41, Q42, Q43 and Q44 are MOS field-effect transistors (MOSFETs), each functioning as a switching element.

The transistor Q41 has a drain connected to ground (GND) and a source connected to an anode of the diode D41. The transistor Q42 has a drain connected to a cathode of diode D42 and a source connected to ground. A coil L41 is connected between an interconnection point of a cathode of the diode D41 and an anode of the diode D42 and one of the electrodes (X electrode) of the panel capacitance CP41.

Diodes D43 and D44 are connected in series between a first voltage CPSH and a second voltage CPSL. An interconnection point of the diodes D43 and D44 is connected to an interconnection point of the diodes D41 and D42.

The coil L41, transistors Q41 and Q42 and diodes D41 to D44 comprise a power recovery circuit.

The transistor Q43 has a drain connected to the first voltage CPSH and a source connected to the X electrode of the panel capacitance CP41. The transistor Q44 has a drain connected to the X electrode of the panel capacitance CP41 and a source connected to the second voltage CPSL.

The first voltage CPSH is a positive voltage (+Vs) supplied from the power supply module 20, while the second voltage CPSL is a negative voltage (−Vs) supplied from the power supply module 20. In a specific period, the supplied first voltage CPSH could be a positive voltage (+Vs) on which a voltage Ve is superimposed, and similarly the supplied second voltage CPSL could be a negative voltage (−Vs) on which a voltage (−Ve) is superimposed, however, the first voltage CPSH is a positive voltage (+Vs) and the second voltage CPSL is a negative voltage (−Vs) in the description below.

Each of the transistors Q41 to Q44 is supplied with a control signal through its gate and is controlled to turn ON/OFF by the control signal as a switching element.

In the case where the first voltage CPSH, in other words, a positive voltage (+Vs), is applied to the X electrode of the panel capacitance CP41, the transistor Q41 is first turned ON and other transistors Q42 to Q44 are turned OFF. This discharges recovered power (charges) due to LC resonance of the panel capacitance CP41 and the coil L41, and then a voltage of the X electrode of the panel capacitance CP41 rises toward the first voltage CPSH. Subsequently, the transistor Q43 is turned ON and the transistor Q41 is turned OFF, the voltage of the X electrode of the panel capacitance CP41 is clamped to the first voltage CPSH, and the first voltage CPSH is sustained from then on. Then, the transistor Q43 is turned OFF.

In the case where the second voltage CPSL, in other words, a negative voltage (−Vs), is applied to the X electrode of the panel capacitance CP41, the transistor Q42 is first turned ON and other transistors Q41, Q43 and Q44 are turned OFF. This recovers power (charges charged in the panel capacitance CP41) of the panel capacitance CP41 due to the LC resonance of the panel capacitance CP41 and coil L41, and a voltage of the X electrode of the panel capacitance CP41 falls from the first voltage CPSH toward the second voltage CPSL. After turning ON the transistor Q44 and OFF the transistor Q42, the voltage of the X electrode of the panel capacitance CP41 is clamped to the second voltage CPSL and sustained. Then, the transistor Q44 is turned OFF.

By controlling each of the transistors Q41 to Q44 to turn ON/OFF as described above, positive and negative sustain pulses Psp and Psn are applied to the X electrode of the panel capacitance CP41.

Although, the MOS field-effect transistors Q41 to Q44 are used as switching elements in the example shown in FIG. 4A, it is also possible to use a switching circuit 41 using an IGBT (Insulated Gate Bipolar Transistor) Q45 as shown in FIG. 4B instead of the MOS field-effect transistors. In the case of the IGBT Q45, a diode D45 is connected between the collector and emitter of the IGBT Q45.

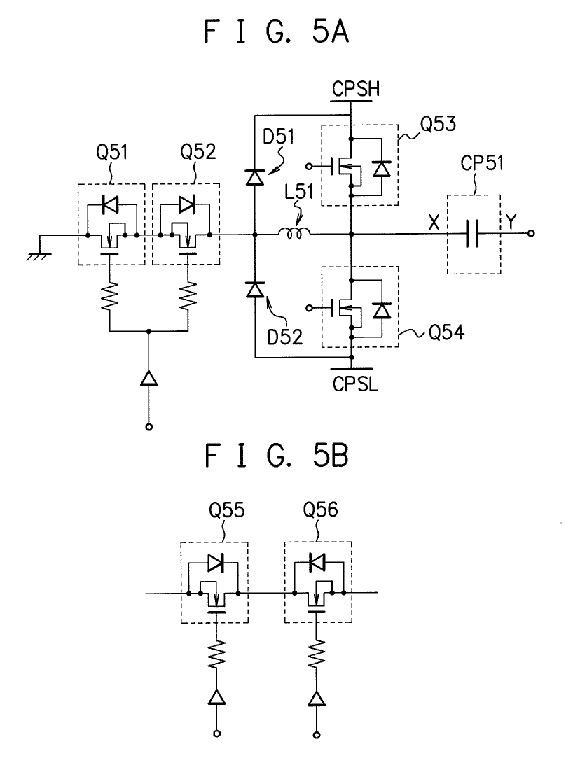

FIGS. 5A and 5B are circuit diagrams showing another configuration examples of the sustain circuits 12 and 14 according to the embodiment. FIG. 5A illustrates a configuration of the X sustain circuit 12 as an example, and the Y sustain circuit 14 also has the same configuration. In the sustain circuit of FIG. 5A, the switch components (corresponding to the transistors Q41 and Q42 and diodes D41 and D42) for the power recovery circuit in the sustain circuit in FIG. 4A are modified into bidirectional switches.

In FIG. 5A, panel capacitance CP51 is a capacitance between the X electrode Xi and Y electrode Yi. Transistors Q51, Q52, Q53 and Q54 are MOS field-effect transistors.

The transistor Q51 has a drain connected to ground (GND) and a source connected to a source of the transistor Q52. The coil L51 is connected between a drain of the transistor Q52 and one electrode (X electrode) of the panel capacitance CP51. Diodes D51 and D52 are connected in series between a first voltage CPSH and a second voltage CPSL, and an interconnection point of the diodes D51 and D52 is connected to an interconnection point of the drain of the transistor Q52 and the coil L51. The coil L51, transistors Q51, Q52 and diodes D51, D52 comprise a power recovery circuit.

The transistor Q53 has a drain connected to the first voltage CPSH and a source connected to the X electrode of the panel capacitance CP51. The transistor Q54 has a drain connected to the X electrode of the panel capacitance CP51 and a source connected to the second voltage CPSL.

Each of the transistors Q51 to Q54 is supplied with a control signal from its gate and is controlled to turn ON/OFF by the control signal. As shown by FIG. 5A, the transistors Q51 and Q52 can be commonly driven by supplying the same control signal to their gates.

The sustain circuit shown in FIG. 5A is the same as the sustain circuit shown in FIG. 4A except for that the power recovery circuit includes the bidirectional switch configuration, and therefore the description regarding its operation will be omitted.

As in the case of the example shown in FIG. 4A, it is also possible to use a switching circuit using the IGBT as shown in FIG. 4B instead of the MOS field-effect transistors Q51 to Q54.

In addition, although the bidirectional switch is formed by connecting the sources (emitters) of the transistors Q51 and Q52 in the example shown in FIG. 5A, the bidirectional switch also can be formed by connecting the drains (collectors) of the transistors Q55 and Q56, which correspond to the transistor Q51 and Q52 respectively, as shown in FIG. 5B. In this case, each of the transistors Q55 and Q56 is supplied with a control signal from its gate and controllably driven independently. Note that the transistor Q55 has a source connected to ground and the transistor Q56 has a source connected to the coil L51, which is not illustrated in FIG. 5B.

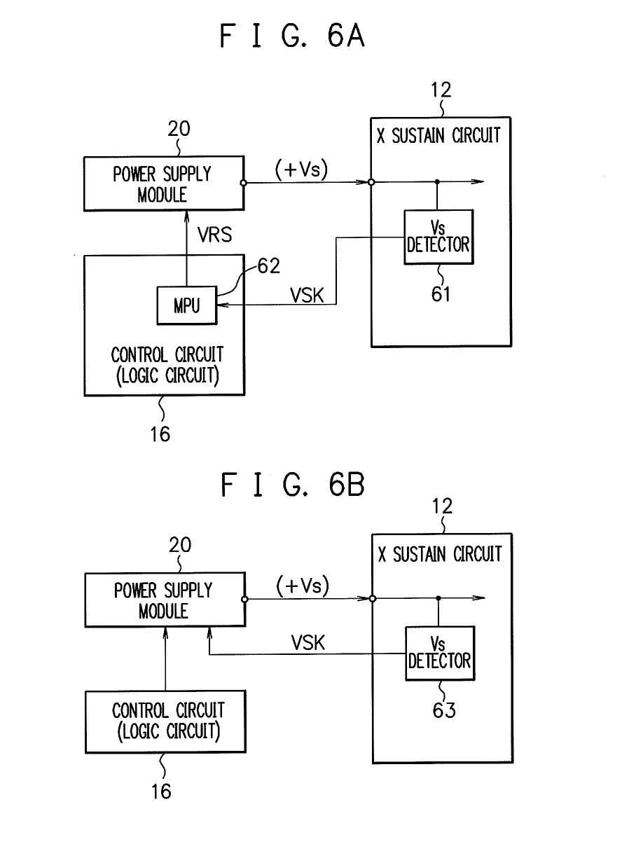

In the above description, the feedback control for output voltages (+Vs, −Vs) is performed with the voltage detector 33 provided in the power supply module 20. However, as shown in FIGS. 6A and 6B, the voltage detector can be provided in the PDP module 10 to perform the feedback control for output voltages (+Vs, −Vs) of the power supply module 20 based on the detection result. FIG. 6B shows a configuration in which a detection result VSK of the voltage is directly sent back to the power supply module 20 and switching of power in the power supply module 20 is controlled in synchronization with the operation of the sustain circuit 12, whereby the fluctuations in voltage of a power supply line caused by changes in a display load can be reduced to a minimum. FIG. 6A shows a configuration in which the voltage fluctuations caused by variations of the individual power supply can be reduced by adding a feedback from the logic circuit 16 in addition to the typical feedback control performed in the power supply module 20. Furthermore, the combination of the configurations shown in FIGS. 6A and 6B can improve control efficiency.

For example, with variations in load in accordance with images displayed on the PDP 11 in the PDP module 10, it is assumed that output voltage from the power supply module 20 is varied. To prevent this, a feedback control for the output voltages (+Vs, −Vs) is performed in response to the load variations in the PDP module 10 with a voltage detector provided in the PDP module 10, thereby narrowing the variations in the output voltage of the power supply module 20.

FIGS. 6A and 6B illustrate schematic configuration examples in which the voltage detectors 61, 63 for detecting a positive voltage (+Vs) are provided in the X sustain circuit 12 of the PDP module 10, however, the present invention is not limited to this but various changes are available.

In the case where the voltage detector is provided in the PDP module 10, as shown in FIG. 6A, an MPU 62 in the control circuit 16 is supplied with a detection result VSK made by the voltage detector 61 and generates a voltage control signal VRS in accordance with the detection result VSK. The feedback control can be performed by supplying this voltage control signal VRS to the power supply module 20 and allowing the power control circuit 34 to control the transistor Q31 to turn ON/OFF based on the voltage control signal VRS.

In addition, as shown in FIG. 6B, the feedback control can be performed by directly supplying the detection result VSK made by the voltage detector 63 to the power supply module 20 and allowing the power control circuit 34 to control the transistor Q31 to turn ON/OFF based on the detection result VSK. This configuration can have a shorter feedback length compared with the configuration shown in FIG. 6A.

Generally, plasma display panels have their own individual operating margins, and therefore their appropriate voltage (+Vs, −Vs) values are different. To deal with the variations, it is possible to provide an output-voltage regulation function, which can appropriately control the output voltages (+Vs, −Vs) output from the power supply module 20, to the PDP module 10 with the use of the configurations shown in FIGS. 6A and 6B in order to automatically regulate the output voltages (+Vs, −Vs) from the power supply module 20 according to the driving margin of the panel.

When the configuration shown in FIG. 6A is used to regulate the output voltages (+Vs, −Vs) of the power supply module 20, for example, the measurement result of the driving margin of the panel is stored in the MPU 62 and the output voltages (+Vs, −Vs) are appropriately set with a voltage control signal VRS based on the measurement result.

The embodiment described above is provided merely by way of example for implementing the present invention, which shall not be construed as limiting the scope of the inventive concept of the present invention. Accordingly, various modifications may be made without departing from the inventive concept or the main features of the present invention.

According to the present invention, a negative voltage required to produce negative sustain pulses in addition to a positive voltage required to produce positive sustain pulses is generated and output in the power supply module for generating DC supply voltage to be supplied to the plasma display panel module from AC supply voltage and outputting the DC supply voltage, thereby effectively generating and outputting the positive voltage and negative voltage without a complex circuit configuration. Furthermore, a feedback control for the output voltage of the power supply module is performed with the detection result supplied from a first voltage detection circuit provided in the plasma display panel module, thereby reducing the variations in the voltage supplied from the power supply module and effectively controlling the voltage.

What is claimed is:

1. A plasma display device comprising:
a plasma display panel module including a plasma display panel with a plurality of electrodes formed therein, a drive circuit applying positive and negative sustain pulses, both having the same absolute value, to the electrodes of said plasma display panel, and a first voltage detection circuit detecting a voltage supplied from a power supply module; and
a power supply module including voltage output terminals connected to voltage input terminals of said plasma display panel module through connection means, said power supply module generating, from an AC supply voltage, a positive voltage required to produce said positive sustain pulses and a negative voltage required to produce said negative sustain pulses, both having the same absolute value and being supplied to said plasma display panel module, and said power supply module outputting the positive and negative voltages from the voltage output terminals, wherein
said power supply module uses a detection result supplied from said first voltage detection circuit to perform a feedback control for an output voltage.

2. The plasma display device according to claim 1, wherein said power supply module performs said feedback control based on either one of the generated positive voltage or negative voltage.

3. The plasma display device according to claim 2, wherein
said plasma display panel module further comprises a control signal generation circuit generating a voltage control signal based on the detection result by said first voltage detection circuit, and
said power supply module performs a feedback control for the output voltage based on the voltage control signal.

4. The plasma display device according to claim 3, wherein
said power supply module comprises:
a transformer including a secondary winding having a ground potential at its center tap;
a switch controlling current supply for a primary winding of said transformer;
a first output rectifier circuit connected to one end of the secondary winding of said transformer and rectifying a secondary current of said transformer to generate said positive voltage;
a second output rectifier circuit connected to the other end of the secondary winding of said transformer and rectifying a secondary current of said transformer to generate said negative voltage;
a second voltage detection circuit detecting an output voltage of said first output rectifier circuit or said second output rectifier circuit; and
a power control circuit controlling said switch based on the output voltage detected by said second voltage detection circuit.

5. The plasma display device according to claim 4, wherein said second voltage detection circuit is provided for either one of said first output rectifier circuit or second output rectifier circuit.

6. The plasma display device according to claim 5, wherein the capacitance of capacitors used to supply charges required for gas discharge by the sustain pulses in said plasma display panel is such that the capacitance of a capacitor in said plasma display panel module is larger than the capacitance of a capacitor in said power supply module.

7. The plasma display device according to claim 6, wherein said plasma display panel module has an output voltage regulation function of appropriately controlling the output voltage of said power supply module.

8. The plasma display device according to claim 7, wherein said power supply module comprises a discharge circuit connected between a positive voltage output terminal for outputting said positive voltage and a negative voltage output terminal for outputting said negative voltage.

9. The plasma display device according to claim 1, wherein
said plasma display panel module further comprises a control signal generation circuit generating a voltage control signal based on the detection result by said first voltage detection circuit, and
said power supply module performs a feedback control for the output voltage based on the voltage control signal.

10. The plasma display device according to claim 1, wherein
said power supply module comprises:
a transformer including a secondary winding having a ground potential at its center tap;
a switch controlling current supply for a primary winding of said transformer;
a first output rectifier circuit connected to one end of the secondary winding of said transformer and rectifying a secondary current of said transformer to generate said positive voltage;
a second output rectifier circuit connected to the other end of the secondary winding of said transformer and rectifying a secondary current of said transformer to generate said negative voltage;
a second voltage detection circuit detecting an output voltage of said first output rectifier circuit or said second output rectifier circuit; and
a power control circuit controlling said switch based on the output voltage detected by said second voltage detection circuit.

11. The plasma display device according to claim 10, wherein said second voltage detection circuit is provided for either one of said first output rectifier circuit or said second output rectifier circuit.

12. The plasma display device according to claim 1, wherein the capacitance of capacitors used to supply charges required for gas discharge by the sustain pulses in said plasma display panel is such that the capacitance of a capacitor in said plasma display panel module is larger than the capacitance of a capacitor in said power supply module.

13. The plasma display device according to claim 1 wherein, said power supply module comprises a discharge circuit connected between a positive voltage output terminal for outputting said positive voltage and a negative voltage output terminal for outputting said negative voltage.

14. A power supply module comprising voltage output terminals electrically connected to voltage input terminals of a plasma display panel module through connection means, generating, from an AC supply voltage, DC supply voltages to be supplied to the plasma display panel module and outputting the DC supply voltages from the voltage output terminals, wherein the power supply module generates and outputs a positive voltage required to produce positive sustain pulses and a negative voltage required to produce negative sustain pulses, both having the same absolute value and being applied to electrodes of the plasma display panel in said plasma display panel module, and performs a feedback control for an output voltage based on a detection result supplied from an external first voltage detection circuit.

15. The power supply module according to claim 14, comprising:
a transformer including a secondary winding having a ground potential at its center tap;
a switch controlling current supply for a primary winding of said transformer;
a first output rectifier circuit connected to one end of the secondary winding of said transformer and rectifying a secondary current of said transformer to generate a positive voltage;
a second output rectifier circuit connected to the other end of the secondary winding of said transformer and rectifying a secondary current of said transformer to generate a negative voltage;
a second voltage detection circuit detecting an output voltage of said first output rectifier circuit or said second output rectifier circuit; and
a power control circuit controlling said switch based on the output voltage detected by said second voltage detection circuit.

16. The power supply module according to claim 15, wherein said second voltage detection circuit is provided for either one of said first output rectifier circuit or said second output rectifier circuit.

17. The power supply module according to claim 15, comprising a discharge circuit connected between a positive voltage output terminal for outputting said positive voltage and a negative voltage output terminal for outputting said negative voltage.
